(19) United States
(12) Patent Application Publication
(10) Pub. No.: US 2026/0201743 A1
(43) Pub. Date: Jul. 16, 2026

(54) METHODS FOR MAKING INSULATING GLASS UNITS

(71) Applicant: CORNING INCORPORATED, CORNING, NY (US)

(72) Inventors: Peter Steven Cole, Corning, NY (US); James Gregory Couillard, Ithaca, NY (US); Michael Aaron McDonald, Painted Post, NY (US)

(21) Appl. No.: 19/132,486

(22) PCT Filed: Nov. 29, 2023
(86) PCT No.: PCT/US2023/081507

§ 371 Date: May 23, 2025

Related U.S. Application Data
(60) Provisional application No. 63/428,495, filed on Nov. 29, 2022.

(51) Int. Cl. E06B 3/663; E06B 3/66; E06B 3/677

(52) U.S. Cl. CPC E06B 3/66366; E06B 3/6617; E06B 3/66328; E06B 3/6775; E06B 3/6612

(57) ABSTRACT

Methods of making an insulated glass unit (IGU) are provided with a thin center pane in a triple IGU (regardless of CTE or glass type/composition), including various embodiments for reducing, preventing, and/or eliminating edge warp when a heated adhesive is utilized as the spacer material in the IGU.

### CROSS-REFERENCE TO RELATED APPLICATIONS

This application claims the benefit of priority under 35 U.S.C. § 119 of U.S. Provisional Application No. 63/428,495 filed Nov. 29, 2022, the content of which is incorporated herein by reference in its entirety.

### FIELD OF THE DISCLOSURE

Generally, the present disclosure is directed towards a triple-pane IGU having a thin (e.g. less than about 2.5 mm thick) center pane that is configured with TPS spacer(s) and methods of making the same. More specifically, the present disclosure is directed towards IGUs and methods of making IGUs to meet thermal requirements (e.g. ENERGY STAR v7) while having reduced and/or eliminated edge warp from the spacer deposition (during manufacturing).

### BACKGROUND

At present, building regulations and energy standards are in flux, with increased emphasis on sustainability, energy usage, and thermal efficiency buildings and building products. With recent proposed changes to energy certification programs, and the recent building trend to increase sizes of windows and/or the number of windows in homes and buildings, there is as strong desire among insulated glass unit makers, window-makers, and builders to light-weight IGUs and windows, while at the same time, meet new, more rigorous energy certifications in various jurisdictions.

### SUMMARY

Surprisingly, the present inventors determined that when using an extruded thermoplastic spacer (TPS), the high temperature spacer bead (upon extrusion/deposition) can create undesirable edge warp in a thin glass substrate used as the center-pane in a thin triple pane insulated glazing unit (IGU). This edge-warp is believed to be attributed to the localized heat affected zone near the edge of the pane from the TPS spacer deposition. When deposited, the spacer is extruded onto the pane (or adhered to the pane) and the spacer bead has a temperature exceeding 100 degrees C. Edge warp in the third pane or center pane can cause deleterious effects during IGU manufacturing and in the finished IGU, including but not limited to: visual distortion; lower manufacturing yields; loss of spacer viability; or gas leak in the IGU; among other items.

In order to manufacture a thin center-pane IGU (e.g. having a thickness of less than about 2 mm; or less than about 1.6 mm, or less than 1 mm), it has been found that edge warp can be reduced and/or eliminated by incorporating one or more embodiments disclosed herein into the IGU manufacturing process, including: preheating the third pane to a preheated temperature (e.g. in the range of 60 degrees C. to 120 degrees C.); mechanically restraining the third pane (to prevent edge warp/deformation when the heated adhesive is placed into contact with the edge of the third pane); and/or cooling (actively and/or passively) the heat affected zone of the third pane. With one or more embodiments described herein, both high CTE and low CTE center-pane glasses may be utilized as the center pane in a thin triple IGU. The resulting IGU will have low to no edge warp; thus, the resulting IGU will have improved features including low to no visual distortion, improved seal integrity, improved/increased manufacturability; and improved field longevity as compared to IGUs without such embodiment(s) (e.g. where, without such techniques described herein, such high CTE thin center-pane IGUs may otherwise experience such deleterious effects during manufacturing and/or in use). Thus, in one or more embodiments set forth herein, a thin CTE center-pane multi-pane IGU with TPS spacers (or other high-temperature deposition spacers) are provided, along with methods of making the same.

In one aspect, a method of making an insulated glass unit (IGU) is provided, comprising: heating a third pane of glass to a preheat temperature, the third pane of glass having a thickness of less than 2.5 mm and having a third coefficient of thermal expansion (CTE 3); applying a first bead of heated adhesive onto a first side of a third pane of glass, contacting a second side of the first pane of glass with the bead of heated adhesive, wherein the first pane of glass has a thickness of at least 2.5 mm and a first coefficient of thermal expansion (CTE 1), applying a second bead of heated adhesive onto a second side of the third pane of glass or a first side of a second pane of glass, contacting a first side of a second pane of glass with the second bead of heated adhesive, wherein the second pane of glass has a thickness of at least 2.5 mm and a second coefficient of thermal expansion (CTE 2), further wherein, via the preheating step, the IGU is configured with no edge warp in the third pane. no visual distortion in the third pane.

In some embodiments, preheating further comprises heating the third pane to an average temperature of at least 60 degrees C.

In some embodiments, preheating further comprises heating the third pane to an average temperature of at least 90 degrees C.

In some embodiments, preheating further comprises heating the third pane to an average temperature in the range of between at least 60 degrees C. to not greater than 120 degrees C.

In some embodiments, the method further comprises mechanically restraining the third pane in a flattened configuration.

In some embodiments, mechanically restraining the third pane further comprises pulling a vacuum across the second side of the third pane.

In some embodiments, pulling a vacuum across the second side of the third pane further comprises engaging a plurality of vacuum holes on a vacuum table with a negative pressure.

In some embodiments, the negative pressure is less than 0 to not greater than −1 atm.

In some embodiments, the vacuum table is further configured with a heating element, such that preheating of the third pane is accomplished via the heated vacuum table.

In some embodiments, mechanically restraining the third pane further comprises mechanically fixturing at least a portion of the perimetrical edges of the third pane to retain the third pane in flattened configuration.

In some embodiments, mechanically fixturing at least a portion of the perimetrical edges of the third pane further comprises affixing the third pane to a support surface via at least one edge fixture along an edge of the third pane.

In some embodiments, mechanically fixturing at least a portion of the perimetrical edges of the third pane further comprises affixing the third pane to a support surface via at least two edge fixtures along at least two edges of the third pane.

In some embodiments, the mechanically fixtured edges are adjacent.

In some embodiments, the edges are non-adjacent (both horizontal or both vertical edges).

In some embodiments, mechanically fixturing at least a portion of the perimetrical edges of the third pane further comprises affixing the third pane to a support surface via at least three edge fixtures along at least three edges of the third pane.

In some embodiments, mechanically fixturing at least a portion of the perimetrical edges of the third pane further comprises affixing the third pane to a support surface via at least four edge fixtures along the four edges of the third pane.

In some embodiments, mechanically fixturing at least a portion of the perimetrical corners of the third pane further comprises affixing the third pane to a support surface via at least two corner fixtures along at least two corners of the third pane.

In some embodiments, the mechanically fixtured corners are adjacent.

In some embodiments, the corners are non-adjacent.

In some embodiments, mechanically fixturing at least a portion of the perimetrical corners of the third pane further comprises affixing the third pane to a support surface via at least three corner fixtures along at least three corners of the third pane.

In some embodiments, mechanically fixturing at least a portion of the perimetrical corners of the third pane further comprises affixing the third pane to a support surface via the four corners fixtures along the four corners of the third pane.

In some embodiments, the mechanical fixtures further comprise brackets, weighted members, clamps, frame components, and/or combinations thereof.

In some embodiments, the method further comprises cooling at least a portion of a heat affected zone in the third pane via a heat sink configured in the support surface for passive cooling. (e.g. heat sink further configured as a metallic support surface, inner surface having heat fins).

In some embodiments, the method further comprises cooling at least a portion of a heat affected zone in the third pane by actively cooling the heat affected zone.

In some embodiments, the actively cooling further comprises a support surface configured with one or more chambers configured with a cooling medium (gas or liquid) to transfer to transfer heat away from the heat affected zone of the third pane into the support surface.

In some embodiments, the method comprises after the contacting step cooling the first heated adhesive bead to define a first spacer seal between the first pane and the third pane.

In some embodiments, a first gas cavity is defined between the first pane, the third pane, and the first spacer seal.

In some embodiments, the method further comprises compressing the IGU by applying compressive force on the first surface of the first pane and the second surface of the second pane.

In some embodiments, compressing further comprises compressing by engaging a plurality of rollers on a first side of the IGU while a second side of the IGU is in contact with a support surface.

In some embodiments, the method comprises after the contacting step, cooling the second heated adhesive bead to define a second spacer seal between the third pane and the second pane.

In some embodiments, a second gas cavity is defined between the third pane, the second pane, and the second spacer seal.

In some embodiments, CTE 3 is less than CTE 1 and wherein CTE 3 is less than CTE 2.

In some embodiments, the composition of the third pane is different from the first pane and the second pane.

In some embodiments, the third pane is a boro aluminosilicate glass.

In some embodiments, the first pane and the second pane are a sodalime glass.

In some embodiments, CTE 3 is the same as CTE 1 and wherein CTE 3 is the same as CTE 2.

In some embodiments, the composition of the third pane is the same as the composition of the first pane and the composition of the second pane.

In some embodiments, the applying step further comprises directing a bead of formable softened adhesive onto the first side of the third pane.

In some embodiments, the applying step further comprises extruding.

In some embodiments, the first heated bead of adhesive and second heated bead of adhesive further comprises a thermoplastic spacer material.

In some embodiments, the first heated bead of adhesive and second heated bead of adhesive are configured with an application temperature average in the range of at least 100 degrees C. to not greater than 130 degrees C.

In some embodiments, contacting a second pane further comprises adhering the adhesive to the second side of the first pane.

In some embodiments, the thickness of the third pane is not greater than 1.6 mm.

In some embodiments, the second pane has a thickness of at least 3 mm.

In some embodiments, the first pane has a thickness of at least 3 mm.

In some embodiments, at least one of the first pane and the second pane are strengthened by: thermal tempering, heat strengthening, or chemically strengthening.

In some embodiments, both the first pane and second pane are strengthened.

In some embodiments, the third pane is configured with a vertical inset and a horizontal inset.

In some embodiments, the third pane is configured with a vertical edge overhang and a horizontal edge overhang.

In some embodiments, the contacting step is completed in an environment or chamber having a first gas therein, such that the first gas is retained in the first gas cavity between the first pane and the third pane via the contacting step.

In some embodiments, the contacting step is completed in an environment or chamber having a second gas therein, such that the second gas is retained in the second gas cavity between the third pane and the second pane via the contacting step.

In some embodiments, the method includes injecting a first gas into a first gas cavity.

In some embodiments, the method includes comprising injecting a second gas into a second gas cavity.

In some embodiments, the method further comprises injecting a first gas into a first gas cavity; and injecting a second gas into a second gas cavity, where the first gas and second gas are the same gases or different gases.

In another aspect, a method of making an insulated glass unit (IGU) is provided, comprising: mechanically restraining a third pane in a flattened configuration, the third pane of glass having a thickness of less than 2.5 mm and having a third coefficient of thermal expansion (CTE 3); applying a first bead of heated adhesive onto a first side of a third pane of glass, contacting a second side of the first pane of glass with the bead of heated adhesive, wherein the first pane of glass has a thickness of at least 2.5 mm and a first coefficient of thermal expansion (CTE 1), applying a second bead of heated adhesive onto a second side of the third pane of glass or a first side of a second pane of glass, contacting a first side of a second pane of glass with the second bead of heated adhesive, wherein the second pane of glass has a thickness of at least 2.5 mm and a second coefficient of thermal expansion (CTE 2), further wherein, via the mechanically restraining step, the IGU is configured with no edge warp in the third pane or no visual distortion in the third pane.

In some embodiments, before the contacting step, the method further comprises, heating a third pane of glass to a preheat temperature.

In some embodiments, mechanically restraining the third pane further comprises pulling a vacuum across the second side of the third pane.

In some embodiments, mechanically restraining the third pane further comprises mechanically fixturing at least a portion of the perimetrical edges and/or corners of the third pane to retain the third pane in flattened configuration.

In some embodiments, the method further comprises cooling at least a portion of a heat affected zone in the third pane via a heat sink configured in the support surface for passive cooling.

In some embodiments, the method further comprises cooling at least a portion of a heat affected zone in the third pane by actively cooling the heat affected zone.

In another aspect, a method of making an insulated glass unit (IGU) is provided, comprising: applying a first bead of heated adhesive onto a first side of a third pane of glass, the third pane of glass having a thickness of less than 2.5 mm and having a third coefficient of thermal expansion (CTE3); concomitant with applying the first bead of heated adhesive, cooling at least a portion of the third pane defined by a heat affected zone of the third pane (e.g. in contact with and/or area adjacent to the heated bead of adhesive); contacting a second side of the first pane of glass with the bead of heated adhesive, wherein the first pane of glass has a thickness of at least 2.5 mm and a first coefficient of thermal expansion (CTE 1), applying a second bead of heated adhesive onto a second side of the third pane of glass or a first side of a second pane of glass, optionally, concomitant with applying the second head of heated adhesive onto the second side of the third pane, contacting a first side of a second pane of glass with the second bead of heated adhesive, wherein the second pane of glass has a thickness of at least 2.5 mm and a second coefficient of thermal expansion (CTE 2), further wherein, via the cooling step, the IGU is configured with no edge warp in the third pane or no visual distortion in the third pane.

In some embodiments, the method further comprises: mechanically restraining a third pane in a flattened configuration.

In some embodiments, mechanically restraining the third pane further comprises pulling a vacuum across the second side of the third pane.

In some embodiments, mechanically restraining the third pane further comprises mechanically fixturing at least a portion of the perimetrical edges and/or corners of the third pane to retain the third pane in flattened configuration.

In some embodiments, the method further comprises, before the first applying step, preheating a third pane of glass to a preheat temperature.

In some embodiments, the method further comprises cooling at least a portion of a heat affected zone in the third pane via a heat sink configured in the support surface for passive cooling.

In some embodiments, the method further comprises cooling at least a portion of a heat affected zone in the third pane by actively cooling the heat affected zone.

In another aspect, an insulating glass unit is provided, comprising: a first pane of glass, having a first side and a second side, a first thickness of at least 2.5 mm, and a CTE 1;
a second pane of glass, having a first side and a second side, a second thickness of at least 2.5 mm, and a CTE 2; and a third pane of glass, having a first side and a second side, having a third thickness of not greater than 2.5 mm, and a CTE3, a first thermoplastic spacer, positioned between the second side of the first pane and the first side of the third pane to define a first gas cavity having a first cavity depth; and a second thermoplastic spacer, positioned between the second side of the third pane and the first side of the second pane to define a second gas cavity having a second cavity depth, wherein the IGU has no visual distortion of observable edge warp on the third pane.

In some embodiments, the third pane has a thickness of at least 0.3 mm to not greater than 2.2 mm.

In some embodiments, the third pane has a thickness of at least 0.3 mm to not greater than 1.6 mm.

In some embodiments, the third pane has a thickness of at least 0.3 mm to not greater than 1.3 mm.

In some embodiments, the third pane has a thickness of at least 0.45 mm to not greater than 1 mm.

In some embodiments, CTE 3 is less than either of CTE1 and CTE 2.

In some embodiments, the third pane is an alumino borosilicate glass.

In some embodiments, at least one of the first pane and the second pane are a sodalime glass.

In some embodiments, both the first pane and second pane are a sodalime glass.

In some embodiments, CTE 3 is the same as CTE1 and CTE 2.

In some embodiments, the third pane, the second pane, and the first pane are each composed of a sodalime glass.

In some embodiments, the first gas cavity is configured with a gas selected from: air, krypton, argon, and mixtures of at least two of the foregoing.

In some embodiments, the second gas cavity is configured with a gas selected from: air, krypton, argon, and mixtures of at least two of the foregoing.

In some embodiments, the third pane has a vertical inset as compared to the first pane and the second pane.

In some embodiments, the third pane has a horizontal inset as compared to the first pane and the second pane. As will be explained in more detail below, these aspects of the present disclosure, alone or in their various combinations, can provide a triple pane IGU which can employ a thin glass sheet as the second sheet of the laminated pane without excessive distortion of the laminated pane.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure and are intended to provide an overview or framework for understanding the nature and character of the claims. The accompanying drawings are included to provide a further understanding of the disclosure and are incorporated into and constitute a part of this specification. The drawings illustrate various embodiments of the disclosure and, together with the description, serve to explain the principles and operations of the disclosure.

### BRIEF DESCRIPTION OF THE DRAWINGS

The following detailed description can be further understood when read in conjunction with the following drawings in which:

FIG. 1 depicts a schematic, cut-away side view of an embodiment of an insulating glass unity (IGU) in accordance with an aspect of the present disclosure;

FIG. 2 depicts a schematic plan side view of FIG. 1, in accordance with one or more aspects of the present disclosure; and

FIG. 3 depicts a schematic side-view of an example of edge-warp attributable to high-temperature spacer positioned adjacent to the edge of a glass substrate, in accordance with aspects of the present disclosure.

### DETAILED DESCRIPTION

Various aspects of the disclosure will now be discussed with reference to FIGS. 1-3, which illustrate aspects of the claimed embodiments, and their components, features, or properties. The following general description is intended to provide an overview of the claimed devices, and various aspects will be more specifically discussed throughout the disclosure with reference to the non-limiting depicted aspects, these aspects generally being interchangeable with one another within the context of the disclosure.

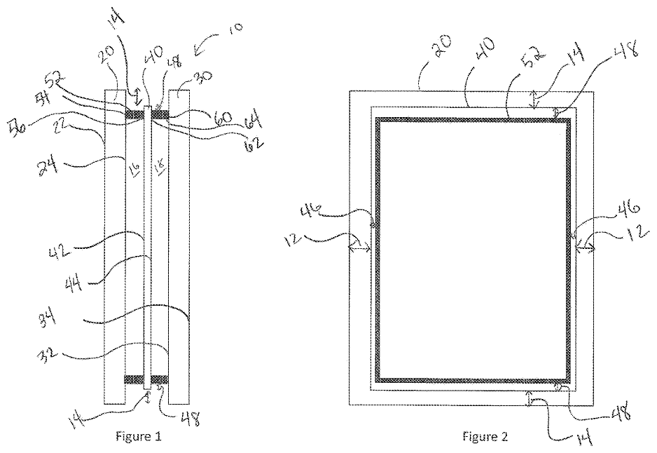

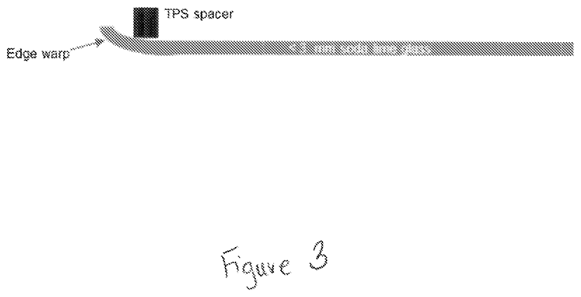

As shown in FIG. 1, a cut-away side-view of a triple pane IGU 10 is depicted. FIG. 2 depicts the front plan view of FIG. 1. Referring to FIGS. 1 and 2, the IGU 10 includes three panes, a first pane 20, a second pane 30, and a third pane 40, with the third pane 40 positioned between the first pane 20 and the second pane 30. The panes 20, 40, and 30 are spaced apart to define two predetermined distances: a gap between the first pane 20 and the third pane 40 and a gap between the third pane 40 and the second pane 30.

The first pane 20 is configured with a cross-sectional thickness, and two major surfaces, a first side of the first pane 22 and a second side of the second pane 24.

The second pane 30 is configured with a cross-sectional thickness, and two major surfaces, first side of second pane 32 and second side of second pane 34.

The third pane 40 is configured with a cross-sectional thickness, and two surfaces, a first side of third pane 42 and a second side of third pane 44.

The predetermined gap between the second side of the first pane 24 and the first side of the third pane 42 and the first spacer 52 defines a first gas cavity 16. More specifically, the first side of the first spacer 54 is in communication with the second side of the first pane 24 and the second side of the first spacer 56 is in communication with the first side of the third pane 42. The predetermined gap between the second side of the third pane 44 and the first side of the second pane 32 and the second spacer 60 defines the second gas cavity 18. More specifically, the first side of the second spacer 62 is in communication with the second side of the third pane 44 and the second side of the second spacer 64 is in communication with the first side of the third pane 32.

In some embodiments, the third pane 40 is configured with an inset (smaller footprint or cross-sectional area) than the first pane 20 or second pane 30. FIG. 1 depicts the first inset 14, where the upper edge and lower edge of the third pane 40 is set inwardly from the respective edges of the upper edges and lower edges of the first pane 20 and second pane 30. Referring to FIG. 2, both the first inset 14 (in a vertical manner) and second inset 12 (in a horizontal manner) is depicted.

In some embodiments, IGU 10 is configured such that the first spacer 52 and second spacer 60 are positioned at a predefined distance from the edge of the third pane 40, to promote seal integrity, ease in formability, and increased yields in manufacturability. In FIG. 1, the overhang of the third pane is represented by first edge overhang 48 (upper edge and lower edge of the third pane 40) in a vertical manner and second edge overhang 46 (side edges of third pane 40, shown in FIG. 2).

In some embodiments, the gas in the gas cavity (first gas cavity or second gas cavity) is: argon, krypton, or air, or mixtures of at least two (e.g. argon and krypton).

In some embodiments, the first inset is: 0.5 mm to 5 mm.

In some embodiments, the second inset is: 0.5 mm to 5 mm.

In some embodiments, the first pane is: sodalime silicate glass.

In some embodiments, the second pane is: sodalime silicate glass.

In some embodiments, the third pane is: an inorganic glass. In some embodiments, the third pane is EAGLE XG®, commercially available from Corning Incorporated.

In some embodiments, the spacer is: a thermoplastic spacer (TPS).

In some embodiments, the thickness of the first spacer is configured to extend along the first gas cavity, such that the cross-sectional thickness of the first spacer is the same so the first gas cavity. In some embodiments, the thickness of the second spacer is configured to extend along the second gas cavity, such that the cross-sectional thickness of the second spacer is the same so the second gas cavity.

In some embodiments, the first edge overhang is: at least 0.5 mm to not greater than 2.5 mm. In some embodiments, the first edge overhang is configured in a vertical dimension, such that the third pane slightly extends from the spacers.

In some embodiments, the second edge overhang is: at least 0.5 mm to not greater than 2.5 mm. In some embodiments, the second edge overhang is configured in a horizontal dimension, such that the third pane slightly extends from the spacers.

In some embodiments, the first pane cross-sectional thickness is: at least 2.2 to not greater than 10 mm. In some embodiments, the first pane cross-sectional thickness is at least 2.5 mm; at least 3 mm; at least 3.5 mm; at least 4 mm; at least 4.5 mm; at least 5 mm; at least 5.5 mm; at least 6 mm; at least 6.5 mm; at least 7 mm; at least 7.5 mm; at least 8 mm; at least 8.5 mm; at least 9 mm; or at least 9.5 mm. In some embodiments, the first pane cross-sectional thickness is: not greater than 3 mm; not greater than 3.5 mm; not greater than 4 mm; not greater than 4.5 mm; not greater than 5 mm; not greater than 5.5 mm; not greater than 6 mm; not greater than 6.5 mm; not greater than 7 mm; not greater than 7.5 mm; not greater than 8 mm; not greater than 8.5 mm; not greater than 9 mm; or not greater than 9.5 mm.

In some embodiments, the second pane cross-sectional thickness is: at least 2.2 to not greater than 10 mm.

In some embodiments, the first pane cross-sectional thickness is at least 2.5 mm; at least 3 mm; at least 3.5 mm; at least 4 mm; at least 4.5 mm; at least 5 mm; at least 5.5 mm; at least 6 mm; at least 6.5 mm; at least 7 mm; at least 7.5 mm; at least 8 mm; at least 8.5 mm; at least 9 mm; or at least 9.5 mm. In some embodiments, the second pane cross-sectional thickness is: not greater than 3 mm; not greater than 3.5 mm; not greater than 4 mm; not greater than 4.5 mm; not greater than 5 mm; not greater than 5.5 mm; not greater than 6 mm; not greater than 6.5 mm; not greater than 7 mm; not greater than 7.5 mm; not greater than 8 mm; not greater than 8.5 mm; not greater than 9 mm; or not greater than 9.5 mm.

In some embodiments, the third pane cross-sectional thickness is: 0.3 to not greater than 3 mm thick.

In some embodiments, the third pane cross-sectional thickness is not greater than 3 mm; not greater than 2.5 mm; not greater than 2 mm; not greater than 1.5 mm; not greater than 1 mm; not greater than 0.5 mm; not greater than 0.3 mm, or not greater than 0.1 mm. In some embodiments, the third pane cross-sectional thickness is: not greater than 2 mm; not greater than 1.7 mm; not greater than 1.5 mm; not greater than 1.3 mm; not greater than 1 mm; not greater than 0.7 mm; not greater than 0.5 mm; not greater than 0.3 mm; or not greater than 0.1 mm.

In some embodiments, the third pane cross-sectional thickness is at least 2.5 mm; at least 2 mm; at least 1.5 mm; at least 1 mm; at least 0.5 mm; at least 0.3 mm, or at least 0.1 mm. In some embodiments, the third pane cross-sectional thickness is at least 1.6 mm; at least 1.3 mm; at least 1 mm; at least 0.8 mm; at least 0.7 mm; at least 0.5 mm, or at least 0.3 mm.

In some embodiments, the third pane cross-sectional thickness is: 0.3 to not greater than 2 mm thick.

In some embodiments, the first gas cavity cross-sectional thickness is: 4 mm thick to not greater than 20 mm thick. In some embodiments, the first gas cavity cross-sectional thickness is: at least 5 mm; at least 7 mm; at least 10 mm; at least 12 mm; at least 14 mm; at least 16 mm; at least 18 mm; or at least 20 mm. In some embodiments, the first gas cavity cross-sectional thickness is: not greater than 7 mm; not greater than 10 mm; not greater than 12 mm; not greater than 14 mm; not greater than 16 mm; not greater than 18 mm; or not greater than 20 mm.

In some embodiments, the second gas cavity cross-sectional thickness is: 4 mm thick to not greater than 20 mm thick.

In some embodiments, the first gas cavity cross-sectional thickness is: at least 5 mm; at least 7 mm; at least 10 mm; at least 12 mm; at least 14 mm; at least 16 mm; at least 18 mm; or at least 20 mm. In some embodiments, the second gas cavity cross-sectional thickness is: not greater than 7 mm; not greater than 10 mm; not greater than 12 mm; not greater than 14 mm; not greater than 16 mm; not greater than 18 mm; or not greater than 20 mm.

In some embodiments, the spacer is configured as a bead that is an extrudate (extruded in high-temperature, softened form such that it is configurable/positionable from a nozzle onto one of the first, second or third panes.

In some embodiments, one or more of the panes is configured with a coating. In some embodiments, the coating is selected from a low emissivity coating, an anti-reflective coating, or combinations thereof. In some embodiments, a low-emissivity coating may be disposed on surface 22, 24, 32, 34, 42, or 44 or combinations thereof.

In some embodiments, the IGU is incorporated with a frame having a seal, into a window. The seal is configured to fit perimetrically around the IGU, while fitting into the frame, such that the seal retainingly engages the IGU into the frame.

The linear coefficient of thermal expansion (CTE) as referenced herein is measured using ASTM standard E831, “Standard Test Method for Linear Thermal Expansion of Solid Materials by Thermomechanical Analysis,” ASTM E228, “Test Method for Linear Thermal Expansion of Solid Materials With a Push-Rod Dilatometer”, or equivalent. As referenced herein, the coefficient of thermal expansion set forth herein are quantified as a coefficient of thermal expansion (CTE) is measured over a temperature range 0-300° C.

The CTE of the third pane is less than 70×10⁻⁷/° C. and greater than zero as measured over a range of from 0 to about 300° C. In some embodiments, the CTE of the third pane is less than 50×10⁻⁷/° C. and greater than zero as measured over a range of from 0 to about 300° C. In some embodiments, the CTE of the third pane is less than about 35×10⁻⁷/° C. and greater than zero, as measured over a range of from 0 to about 300° C.

The first pane and second pane are selected from sodalime glass, a boro-aluminosilicate glass, an alkaline earth boro-aluminosilicate glass, or an alkali-free boro-aluminosilicate glass. The third pane is selected from sodalime glass, a boro-aluminosilicate glass, an alkaline earth boro-aluminosilicate glass, or an alkali-free boro-aluminosilicate glass. Exemplary commercial glass products include, but are not limited to, Corning® EAGLE XG® and Lotus™ NXT glasses. In some embodiments, the first pane or second pane is a float product or fusion draw product. Soda lime glass has a CTE of approximately 90×10⁻⁷/° C. By comparison, Corning EAGLE XG glass has a CTE of approximately 32×10⁻⁷/° C., which is approximately ⅓ (“one-third”) of the CTE of soda lime glass, as measured over a range of from 0 to about 300° C.

In some embodiments, edge warp can be characterized by a non-planar substrate that is visually observed to have an upwardly curling edge. In some embodiments, edge warp can be characterized by visual distortion when trying to look through an area of edge plane, as the index of refraction through the distorted/edge-warped portion of the substrate is different than through the remainder of the substrate (non-curled portion) a non-planar substrate that is visually observed to have an upwardly curling edge. In some embodiments, edge warp is distinguishable from bow as edge warp is localized distortion adjacent to the edge of the substrate (e.g. and can appear as an upward curling in response to a localized high-temperature material being contacted near the edge), whereas bow can act across an entire substrate or portions thereof (not just related to the edge), and can cause displacement end-to-end, appear in a convex or concave manner, or cause a portion or entire substrate to appear bent or curved (as opposed to a localized region near the edge).

While there's not a standard test for edge lift/warp, there are some standards (that apply for tempered glass) that refer to edge lift within a defined zone proximal to the edge with a defined limit. For example, one way to quantify edge warp may be EU standard DIN EN 12150-1 defines edge lift/edge warp for tempered glass as deformation within 100 mm of the edge, and not exceeding 0.5 mm for 3 mm tempered glass. For thinner, untempered glass, edge lift may be more pronounced, though still located proximal to an edge region. As another example, another way to quantify edge lift via visual distortion, may be ASTM C1036 (for flat glass) uses visual inspection of a zebra board as a function of angle, though there are some perceived limitations with this standard, as architectural products (like thin center pane triple IGUS) may not exhibit/show measurable distortion at viewing angles of $35°.

In some embodiments, the third pane is an architecturally-sized substrate. The IGU incorporating the third pane has a cross-sectional area (areal dimension) of at least 2′×5′; at least 3′×7′; or at least 4′×10′, or larger.

In some embodiments, the edge warp is zero to not greater than 3 mm; or zero to not greater than 2 mm; or zero to not greater than 1.5 mm; or zero to not greater than 1 mm; or zero to not greater than 0.7 mm; or zero to not greater than 0.5 mm; or zero to not greater than 0.3 mm. In some embodiments, the edge warp is 0.05 mm to not greater than 3 mm; or 0.1 to not greater than 2 mm; or 0.25 mm to not greater than 1.5 mm.

In some embodiments, edge warp in a substrate (e.g. third substrate) in the IGU is: not greater than 3 mm; not greater than 2.5 mm; not greater than 2 mm; not greater than 1.5 mm; not greater than 1 mm; not greater than 0.5 mm; or not greater 0.1 mm. In some embodiments, edge warp in a substrate (e.g. third substrate) in the IGU is: not greater than 2 mm; not greater than 1.7 mm; not greater than 1.5 mm; not greater than 1.3 mm; not greater than 1 mm; not greater than 0.7 mm; not greater than 0.5 mm; not greater than 0.3 mm; not greater than 0.1 mm; not greater than 0.07 mm; not greater than 0.05 mm; not greater than 0.03 mm; or not greater than 0.01 mm.

In some embodiments, edge warp in a substrate (e.g. third substrate) in the IGU is: at least 2.5 mm; at least 2 mm; at least 1.5 mm; at least 1 mm; at least 0.5 mm; or at least 0.1 mm.

In some embodiments, edge warp in a substrate (e.g. third substrate) in the IGU is: at least 2 mm; at least 1.7 mm; at least 1.5 mm; at least 1.3 mm; at least 1 mm; at least 0.7 mm; at least 0.5 mm; at least 0.3 mm; at least 0.1 mm; at least 0.07 mm; at least 0.05 mm; at least 0.03 mm; or at least 0.01 mm.

It will be appreciated that the various disclosed embodiments can involve particular features, elements or steps that are described in connection with that particular embodiment. It will also be appreciated that a particular feature, element or step, although described in relation to one particular embodiment, can be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a component” includes examples having one such “component” or two or more such “components” unless the context clearly indicates otherwise. Similarly, a “plurality” or an “array” is intended to denote two or more, such that an “array of components” or a “plurality of components” denotes two or more such components.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

All numerical values expressed herein are to be interpreted as including “about,” whether or not so stated, unless expressly indicated otherwise. It is further understood, however, that each numerical value recited is precisely contemplated as well, regardless of whether it is expressed as “about” that value. Thus, “a dimension less than 100 nm” and “a dimension less than about 100 nm” both include embodiments of “a dimension less than about 100 nm” as well as “a dimension less than 100 nm.”

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments can be disclosed using the transitional phrase “comprising,” it is to be understood that alternative embodiments, including those that can be described using the transitional phrases “consisting” or “consisting essentially of,” are implied. Thus, for example, implied alternative embodiments to a device comprising A+B+C include embodiments where a device consists of A+B+C, and embodiments where a device consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure can occur to persons skilled in the art, the disclosure should be construed to include everything within the scope of the appended claims and their equivalents.

### Example: Proxy Experiment to Evaluate Edge Warp in Thin Glass

FIG. 3 depicts glass warp on soda lime glass resulting from the application of a high temperature extruded TPS spacer. Edge warp exhibited by soda lime glass is undesireable and may cause visible optical distortion in the final IGU or window product and/or contribute to higher instances of edge seal failure in the field.

The application of extruded TPS to the glass substrate in IGU manufacturing takes place at elevated temperatures, above 100 degrees C. (the TPS temperature at application can range from 110° C. to 130° C.). A proxy experiment was completed to better-understand and quantify edge-warp of thin glass substrates at different CTEs, when contacted by a high temperature extrudate.

As edge-warp impacts thinner glass more so than thicker substrates, the experiment focused on thin glasses (<1 mm thick) having two different CTEs: a high CTE and a low CTE.

For the high CTE (sodalime glass) samples, 11 samples were completed. For the low CTE (alumino borosilicate glass) samples, 10 samples were evaluated.

All of the samples were coupons of 12″×12″ at 0.7 mm thickness. Edge warp was completed at the same position along the edge of each sample, approximately 6″ (or mid-way) along an edge of a sample. While edges, particularly the SLG sample edges, were visually observed to have varying degrees of edge warp, only 1 location along a sample had a measurement taken. Edge warp was measured by measuring the displacement of the edge of the pane from the flat surface, while the pane was lying on a flat surface. The same position (mid-way between edges) was measured for each sample. Thus, as set out in the table below, although the same measurement tool and method were utilized for each of the high CTE and low CTE samples, the standard deviation for the SLG samples was larger. Without being bound by any mechanism or theory, the higher standard deviation for the high CTE samples may be attributed to the qualitative data noted by the experimental lead, that the high CTE samples exhibited higher instances of edge-warp variation within each sample as compared to each sample of low CTE.

While this experiment utilized an easily ascertainable and quantifiable metric like edge warp, based on the coupon size and experiment design, edge warp or edge distortion in thin sodalime glass can be quantified by an edge bending, non-continuous seal in the resulting IGU and/or gas cavities, or other visual distortion issues based on the visual observation in viewing through the cross-section of the IGU where the center pane has edge warp, among other ways to quantify the problem with thin, high CTE glass vs. thin low CTE glass as set forth herein.

Experimental data on small sample sizes using a hot melt adhesive (~130 degrees C., same manual extrusion process) show that, for the same thickness glass (0.7 mm), high CTE glass (soda lime glass) warps three times more than low CTE glass under the same extrusion conditions. All samples yielded some measurable edge warp, as shown in the table below.

| Sample No. | High CTE | Low CTE |
|---|---|---|
| 1 | −0.66 | −0.33 |
| 2 | −0.34 | −0.14 |
| 3 | −0.83 | −0.05 |
| 4 | −0.86 | −0.11 |
| 5 | −0.44 | −0.26 |
| 6 | −1.11 | −0.24 |
| 7 | −0.95 | −0.2 |
| 8 | −0.46 | −0.16 |
| 9 | −0.91 | −0.06 |
| 10 | −0.6 | −0.08 |
| 11 | −0.48 | — |
| Average | −0.69 | −0.16 |
| Standard | 0.24 | 0.09 |
| Deviation | | |

The high CTE glass exhibited edge warp up to 1.11 mm, while in stark contrast, the highest instance of edge warp measured in the low CTE samples was 0.33 mm. The highest measured edge warp in the low CTE samples was still well-below the average of 0.69 mm edge warp from the high CTE samples. Notably, the average edge warp in the low CTE samples was 0.16 mm, well below all measured edge warp values of the high CTE.

While this proxy, bench-top experiment of manual deposition of the extrudate, it is expected that larger scale manufacturing of architecture-sized substrates and higher deposition rate of TPS (than the manual experiment) retain these trends with SLG exhibiting increased edge warp, even higher so than the low CTE substrates. Without being bound by any particular mechanism or theory, it is believed that the application of a heated adhesive (e.g. extruded TPS spacer having an average deposition temperature in the range of at least 110° C. to not greater than 130° C.) is a localized, non-uniform, very elevated temperature at the edge which can cause edge warp on soda lime glass compositions with a higher CTE (e.g. CTE in the range of 85-95×10⁻⁷/° C.) when glass thickness are below 3 mm. The edge warp is believed to be even more exacerbated as the thickness decreases. On the other hand, in stark contrast, the edge warp on the borosilicate glass evaluated herein (e.g. with a low CTE of approximately 32×10⁻⁷/° C.), even at thin cross-sectional thicknesses, showed significantly less edge warp.

### REFERENCE NUMBERS

IGU 10
first gas cavity 16
first gas cavity 18
first inset 12
second inset 14
first pane 20
first side of first pane 22
second side of first pane 24
second pane 30
first side of second pane 32
second side of second pane 34
third pane 40
first side of third pane 42
second side of third pane 44
first edge overhang 46
second edge overhand 48
spacer bead (extrudate) 50
first spacer 52
first side of first spacer 54
second side of first spacer 56
second spacer 60
first side of second spacer 62
second side of second spacer 64
coatings (optionally: second side of first pane and/or first side of second pane)

1.-68. (canceled)

69. An insulating glass unit, comprising:
a. a first pane of glass, having a first side and a second side, a first thickness of at least 2.5 mm, and a CTE 1;
b. a second pane of glass, having a first side and a second side, a second thickness of at least 2.5 mm, and a CTE 2; and
c. a third pane of glass, having a first side and a second side, having a third thickness of not greater than 2.5 mm, and a CTE3,
d. a first thermoplastic spacer, positioned between the second side of the first pane and the first side of the third pane to define a first gas cavity having a first cavity depth; and
e. a second thermoplastic spacer, positioned between the second side of the third pane and the first side of the second pane to define a second gas cavity having a second cavity depth,
wherein the IGU has no visual distortion of observable edge warp on the third pane.

70. The IGU of claim 69, wherein the third pane has a thickness of at least 0.3 mm to not greater than 2.2 mm.

71. The IGU of claim 69, wherein the third pane has a thickness of at least 0.3 mm to not greater than 1.6 mm.

72. The IGU of claim 69, wherein the third pane has a thickness of at least 0.3 mm to not greater than 1.3 mm.

73. The IGU of claim 69, wherein the third pane has a thickness of at least 0.45 mm to not greater than 1 mm.

74. The IGU of claim 69, wherein CTE 3 is less than either of CTE1 and CTE 2.

75. The IGU of claim 69, where the third pane is an alumino borosilicate glass.

76. The IGU of claim 69, where at least one of the first pane and the second pane are a sodalime glass.

77. The IGU of claim 69, where both the first pane and second pane are a sodalime glass.

78. The IGU of claim 69, wherein CTE 3 is the same as than either of CTE1 and CTE 2.

79. The IGU of claim 69, wherein the third pane, the second pane, and the first pane are each composed of a sodalime glass.

80. The IGU of claim 69, wherein the first gas cavity is configured with a gas selected from: air, krypton, argon, and mixtures of at least two of the foregoing.

81. The IGU of claim 69, wherein the second gas cavity is configured with a gas selected from: air, krypton, argon, and mixtures of at least two of the foregoing.

82. The IGU of claim 69, wherein the third pane has a vertical inset as compared to the first pane and the second pane.

83. The IGU of claim 69, wherein the third pane has a horizontal inset as compared to the first pane and the second pane.

84. The IGU of claim 69, wherein the IGU has no visual distortion of observable edge warp on the third pane within 100 mm from a peripheral edge of the third pane.

85. The IGU of claim 69, wherein the third pane has an edge warp of no more than 2 mm within 100 mm from any peripheral edge of the third pane.

86. The IGU of claim 69, wherein the third pane has an edge warp of no more than 1 mm within 100 mm from any peripheral edge of the third pane.

87. The IGU of claim 69, wherein the third pane has an edge warp of no more than 0.5 mm within 100 mm from any peripheral edge of the third pane.

88. The IGU of claim 69, wherein the IGU has an areal dimension of at least 2 feet by 5 feet.
